(19) United States
(12) Patent Application Publication
(10) Pub. No.: US 2016/0159419 A1
(43) Pub. Date: Jun. 9, 2016

(54) SYSTEM AND METHOD FOR SERVICING LOAD ROLLERS IN UNDERCARRIAGE ASSEMBLY

(71) Applicant: Caterpillar Global Mining LLC, Oak Creek, WI (US)

(72) Inventors: Gnanasekar Jeevanantham, Chennai (IN); Brett E. Burke, Washington, IL (US)

(73) Assignee: Caterpillar Global Mining LLC, Oak Creek, WI (US)

(21) Appl. No.: 15/045,253

(22) Filed: Feb. 17, 2016

(51) Int. Cl. B62D 55/32; B60T 1/00

(52) U.S. Cl. CPC B62D 55/32; B60T 1/005

(57) ABSTRACT

A method for servicing load rollers in undercarriage assembly is provided. The method comprises coupling a service tool with a forklift of a forklift truck in a forward direction and locking the chock with the service tool, wherein the service tool includes at least one vertical pipe and the coupling of the service tool in the forward direction does not require manual intervention. The method further pushes the chock underneath the undercarriage assembly till the at least one vertical pipe touches the undercarriage assembly, decoupling the chock from the service tool without any manual intervention, coupling the service tool with the forklift of the forklift truck in a reverse direction, the service tool optionally utilizes attachment modules, pins and a lock module depending on a size and weight of the load roller, wherein the coupling of the service tool in the reverse direction does not require manual intervention, and positioning the service tool into the undercarriage assembly for performing one of the installing and removing operation of the load roller.

### TECHNICAL FIELD

The present disclosure relates to method and system for servicing an undercarriage assembly, and more specifically, to a method and system for performing installing and removing operations of load rollers from the undercarriage assembly.

### BACKGROUND

Heavy machines, such as large hydraulic excavators are used for a variety of purposes in industrial environments. These machines include an undercarriage assembly that employs load rollers. Depending on the worksite conditions and the type and weight of the machine, the load rollers may require timely maintenance. Many a times, the load rollers need to be removed from the machine during scheduled maintenance for repairing or for complete replacement.

Conventionally, specialized tools are required for suspending the undercarriage assembly and replacing the load rollers from the undercarriage assembly. Generally, such tools are bulky, and therefore difficult to operate within the undercarriage assembly due to limited space therein. For removing load rollers during the scheduled maintenance, such tools also need to be coupled manually with other machines, such as a crane, a hydraulic jack, among others. As a result, the scheduled maintenance becomes unsafe, time-consuming, labor-intensive and cost inefficient, among others.

U.S. Pat. No. 4,268,019 discloses a fixture for repairing track links. The fixture has support members having multiple locating pins. The support members position the track links in the multiple locating pins. Further, the fixture has multiple clamping bars to secure the aligned links in place on the support members. The clamping bars extend through a group of laterally aligned links. Further, a method is disclosed for separating a link assembly into its individual links. The individual links are mounted in longitudinally aligned and side-to-side relationship on the fixture. The proposed method and system described herein offer an economical and expeditious procedure for repairing of the track links. However, such fixture is not suitable for a replacing the load rollers. Therefore, there is a need for a method and system for installing the chock underneath the undercarriage assembly and performing the installing and removing operations of the load rollers from the undercarriage assembly.

### SUMMARY OF THE DISCLOSURE

In one aspect of the present disclosure, a system for servicing the undercarriage assembly is disclosed. The system includes a service tool and a chock. The service tool is capable of being coupled with a forklift of a forklift truck in one of a forward direction and a reverse direction. The service tool includes at least one vertical pipe and optionally uses attachment modules, pins and a lock module depending on a size and weight of a load roller. The chock is configured to be coupled with the service tool in the forward direction. The chock is pushed underneath the undercarriage assembly till the at least one vertical pipe of the service tool touches the undercarriage assembly and further the chock is decoupled from the service tool. The service tool is further coupled with the forklift of the forklift truck in the reverse direction and the service tool is positioned into the undercarriage assembly for performing one of an installing and removing operation of the load roller from the undercarriage assembly.

In another aspect of the present disclosure, a method for fixing a chock underneath an undercarriage assembly and further performing one of an installing and removing operation of a load roller from the undercarriage assembly is disclosed. The method comprises coupling a service tool with a forklift of a forklift truck in a forward direction and locking the chock with the service tool, wherein the service tool includes at least one vertical pipe and the coupling of the service tool in the forward direction does not require manual intervention. The method further includes pushing the chock underneath the undercarriage assembly till the at least one vertical pipe touches the undercarriage assembly, decoupling the chock from the service tool without any manual intervention, coupling the service tool with the forklift of the forklift truck in a reverse direction, the service tool optionally utilizes attachment modules, pins and a lock module depending on a size and weight of the load roller, wherein the coupling of the service tool in the reverse direction does not require manual intervention, and positioning the service tool into the undercarriage assembly for performing one of the installing and removing operation of the load roller.

Other features and aspects of this disclosure will be apparent from the following description and the accompanying drawings.

### BRIEF DESCRIPTION OF THE DRAWINGS

FIG. 1 is a side view of a machine, i.e. a large hydraulic excavator machine supported by two chocks during maintenance, according to the concepts of the present disclosure;

FIG. 2 is an exploded perspective view of a forklift truck having a forklift attached with a service tool in a forward direction and a chock coupled to the service tool, according to the concepts of the present disclosure;

FIG. 3 is a perspective view of the service tool with optional attachments, according to the concepts of the present disclosure;

FIG. 4 is a perspective view of the service tool positioned inside the undercarriage assembly to replace the load roller, according to the concepts of the present disclosure;

FIG. 5 is a perspective view of a load roller placed on the service tool coupled with the forklift in a reverse direction, according to the concepts of the present disclosure; and

FIG. 6 is a flow diagram of a method for servicing the undercarriage assembly, according to the concepts of the present disclosure.

### DETAILED DESCRIPTION

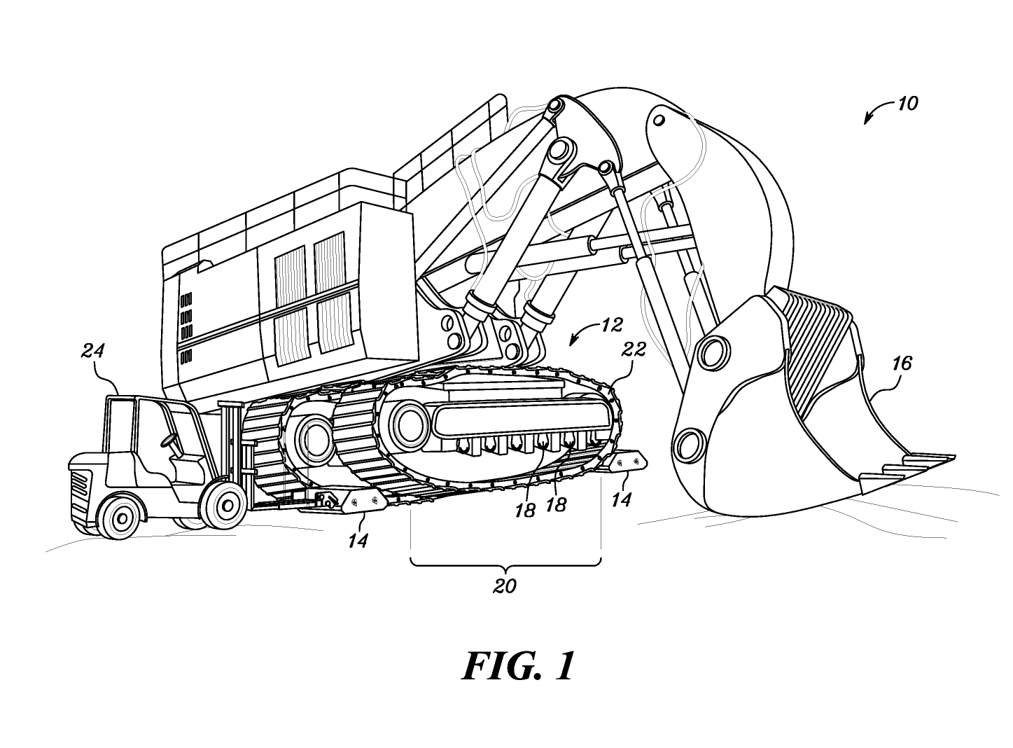

FIG. 1 is a side view of a machine 10, i.e. a large hydraulic excavator machine 10 supported by two chocks 14 during maintenance, according to the concepts of the present disclosure. The terms the machine 10 and the large hydraulic excavator machine 10 are interchangeably used within the specification without departing from the meaning and scope of the disclosure. Examples of the machine 10 may include, but are not limited to, a dozer, a miner machine, a track loader, a shovel machine etc. The machine 10 includes an undercarriage assembly 12, and a bucket 16. In an embodiment of the disclosure, the machine 10 may further include various other components, such as an arm, a cabin and so on. For the purpose of simplicity, the various components of the machine 10 are not labeled in FIG. 1. Various components of the machine 10 require regular maintenance to ensure proper functioning of the machine 10. For example, the undercarriage assembly 12 and its components, such as load rollers 18, etc. require timely maintenance for proper operation of the machine 10. Typically for this purpose, the undercarriage assembly 12 is supported by two chocks 14 for easy access by a user to carry out maintenance of the load rollers 18. The user may be a worker, an operator, or a maintenance person, etc who is capable of executing the maintenance.

A forklift truck 24 places the chocks 14 underneath the undercarriage assembly 12. In an embodiment, the bucket 16 of the machine 10 is on a ground in force which actually helps the machine 10 to lift vertically to give way to place the chock 14 underneath the undercarriage assembly 12. In an embodiment, the chocks 14 are positioned underneath the undercarriage assembly 18 in order to generate a slack 20 in a chain 22. The slack 20 decouples the chain 22 from the load rollers 18. As a result, the slack 20 in the chain 22 facilitates the user to carry out maintenance, for example, installing and removing of the load rollers 18 from the undercarriage assembly 12 using a service tool 32. It would be apparent to one skilled in the art that the use of the chocks 14 is not limited to carrying out maintenance of the undercarriage assembly 12 of the machine 10 only, but the chocks 14 may be utilized for other purposes without departing from the meaning and scope of the disclosure.

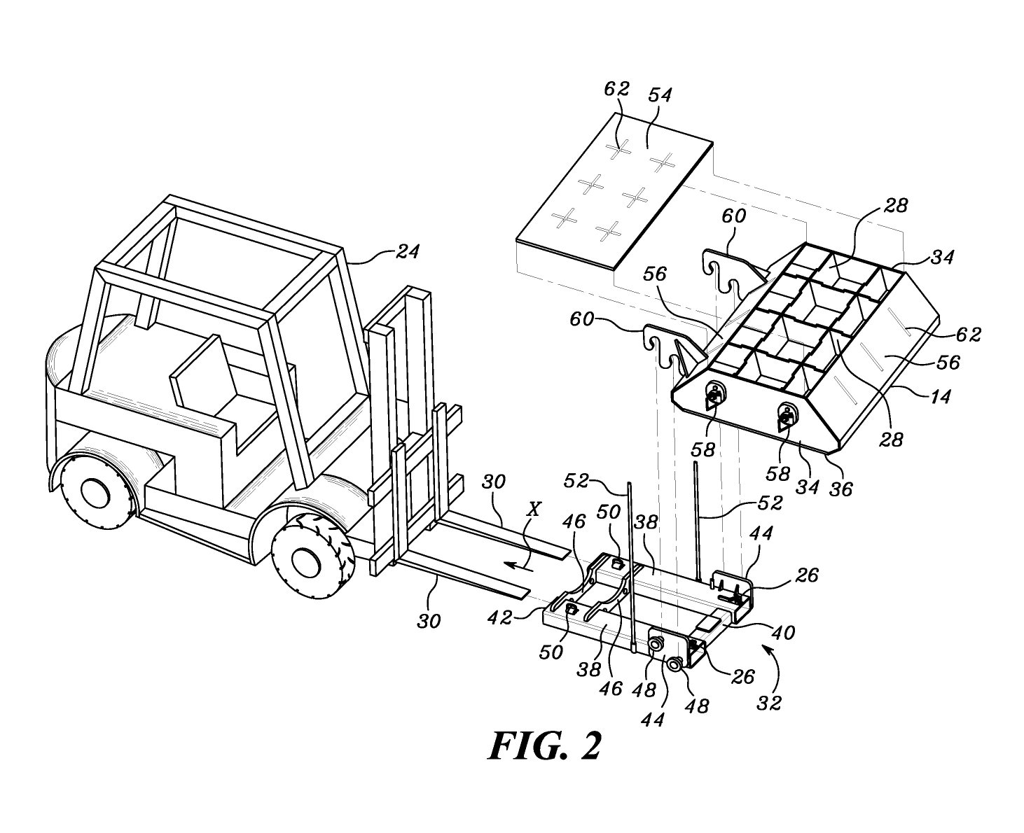

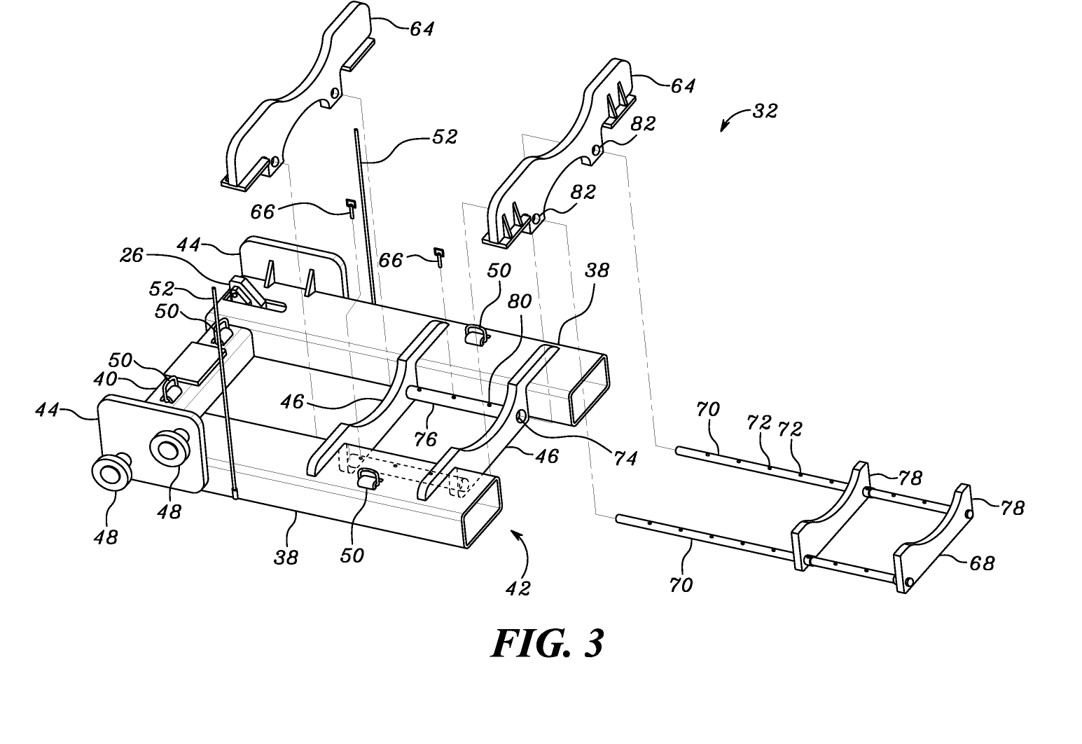

Referring to FIG. 2 and FIG. 3, the service tool 32 is coupled with a forklift 30 of the forklift truck 24 in a forward direction and further locking the chock 14 with the service tool 32. The service tool 32 includes bar members 38, a first member 40, a stop 26, a second edge 42, plates 44, frames 46, pins 48, hooks 50, and vertical pipes 52. The two bar members 38 are coupled with the first member 40 and the frames 46 to form a rectangular shape structure called as the service tool 32. The frames 46 and the first member 40 are coupled in a perpendicular direction with respect to an axis of the bar members 38. One of the frame 46 is coupled with the bar members 38 at an off position from the second edge 42. The frames 46 and the first member 40 coupled with the bar members 38 in such a way that the bar members 38 don't deviate with respect to each other. The bar members 38 includes the plates 44 that has the pins 48. The pins 48 are used for coupling the chock 14 as described in the following paragraphs. The hooks 50 sit on the bar members 38 (also called rails) are used to connect the chains 22 or sling to restrict the movement of the load rollers 18 in the reverse configuration. Further, the hooks 50 on the first member 40 (also called front rail 40) (see FIG. 3) are used to connect the chains 22 to restrict the movement of the service tool 32 in the forward configuration. The stop 26 restricts the fork lift 30 to move beyond the stop 26 while in the forward configuration. It would be apparent to one skilled in the art that the service tool 32 may utilize other components and has other designs without departing from the meaning and scope of the disclosure.

Referring to FIG. 2 and FIG. 3, the chock 14 includes an upper member 54, slant members 56, hooks 58, internal plates 28, and brackets 60. The chock 14 further includes a bottom member 36, and side members 34. The slant members 56 are spaced apart and attached with the upper member 54 and the bottom member 36. In an embodiment, a surface area of the bottom member 36 is greater that the surface area of the upper member 54. The side members 34 are spaced apart and are attached with the upper member 54, the bottom member 36, and the slant members 56 via the internal plates 28. In an embodiment, one of a slant member 56 includes the brackets 60. The side members 34 include the hooks 58. The upper member 54 and the slant members 56 have impressions 62 for welding the internal plates 28 with the upper member 54. The chock 14 rests on a surface via the bottom member 36. The forklift truck 24 moves the service tool 32 towards the chock 14 in such a way that the pins 48 of the service tool 32 are locked within the bracket 60 of the chock 14. The chock 14 in conjunction with the service tool 32 is designed to ensure that the chock 14 is positioned safely under a suspended load. Therefore, the chock 14 is coupled with the service tool 32 without any manual intervention. It would be apparent to one skilled in the art that the chock 14 may have other sizes/weights/designs without departing from the meaning and scope of the disclosure. Upon coupling, the forklift truck 24 is moved toward the machine 10 and the chocks 14 are positioned underneath the undercarriage assembly 12 as shown in FIG. 1. In some embodiment, the chocks 14 are pushed tightly underneath the undercarriage assembly 12 till the at least one vertical pipe 52 touches the undercarriage assembly 12. In this condition, the vertical pipes 52 act as a visual aid to indicate an operator of the forklift truck 24 that the chock 14 has been fully inserted in a correct position and to a desired length underneath the undercarriage assembly 12. Further, the operator may need to get off the forklift truck 24 to verify the positions of the chock 14. After positioning the chocks 14 underneath the undercarriage assembly 12, the chocks 14 are decoupled from the service tool 32 without any manual intervention. Under such configuration, the undercarriage assembly 12 is supported on the two chocks 14 as shown in FIG. 1. Thereafter, the service tool 32 is utilized for further procedures as described in subsequent paragraphs.

Referring to FIG. 2 and FIG. 3, the service tool 32 may optionally utilize various additional attachments according to a size and weight of the load rollers 18. Examples of the additional attachments include, but are not limited to, a lock module 68, locking pins 66, attachment modules 64, etc. The lock module 68 includes first pipes 70 having supports 78 with multiple holes 72 on a surface of the first pipes 70. In an embodiment, the supports 78 are positioned at a specific distance with respect to each other and provide strength to the lock module 68. The lock module 68 is inserted inside second pipes 76 of the service tool 32 via a cavity 74. Thereafter, the lock module 68 is locked with the service tool 32 by inserting the locking pins 66 into the holes 80 and the holes 72. In such configuration, the holes 80 and the holes 72 overlap with each other and such position is fixed via the locking pins 66. As a result, the lock module 68 is firmly coupled with the service tool 32 for various operations. The length of the lock module 68 within the service tool 32 may also be varied as per the requirements. The service tool 32 may also employ the attachment modules 64 depending on the size and weight of the load roller 18. The attachment module 64 has holes 82 that are used for receiving the first pipes 70 of the lock module 68 and the attachment module 64 gets fixed between the bar members 38. It would be apparent to one skilled in the art that there may be other attachment modules (not shown here) to be coupled with the service tool 32 for carrying out maintenance without departing from the meaning and scope of the disclosure. The service tool 32 is designed in such a way that coupling of the service tool 32 with the forklift 30 in the forward direction or in the reverse direction requires minimal or no manual intervention. It would be apparent to one skilled in the art that the service tool 32 may have any other size, weight, design, structural components without departing from the meaning and scope of the disclosure.

In an embodiment, the service tool 32 is coupled with the forklift 30 in the forward direction X using the bar members 38 and a lock-in mechanism (not shown). For example, the service tool 32 is adapted to be coupled with the forklift 30 by moving the forklift 30 opposite to the forward direction X within the bar members 38. As a result, the forklift 30 moves inside a hollow portion of the bar members 38 and is then locked with service tool 32. The coupling of the service tool 32 with the forklift 30 does not require any manual intervention. It would be apparent to one skilled in the art that the service tool 32 may be coupled with the forklift 30 by using various other coupling mechanisms (not shown and described here) and in any other orientation suitable to carry out the maintenance without departing from the meaning and scope of the disclosure.

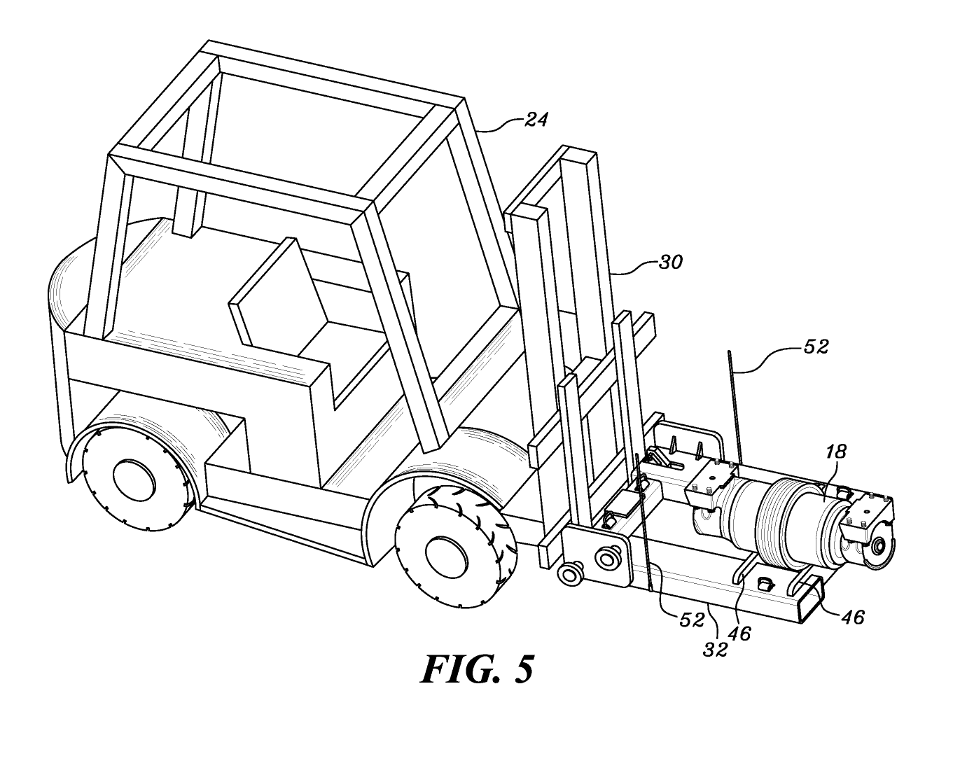

In the reverse configuration, the service tool 32 is coupled with the forklift 30 in a reverse direction. For example, the service tool 32 is adapted to be coupled with the forklift 30 by moving the forklift 30 within the bar members 38 towards the first member 40. As a result, the forklift 30 moves inside the hollow portion of the bar members 38 via the first member 40 and then the service tool 32 is locked with the forklift 30. The stop 26 restricts blades of the fork lift 30 to move beyond the stop 26 while in the forward configuration. In other words, the service tool 32 is coupled with the forklift 30 with the first member 40 moving towards the forklift 30 and the second edge 42 faces the front (as shown in FIG. 5). The reverse configuration of the service tool 32 (as shown in FIG. 5) is opposite to a forward configuration of the service tool 32 (as shown in FIG. 2). The service tool 32 is utilized to carry the chock 14 and then place the chock 14 underneath the undercarriage assembly 12, while the service tool 32 is coupled with the forklift 30 in the forward direction. Similarly, the service tool 32 is utilized to carry out maintenance, for example, installing and removing of the load roller 18 from the undercarriage assembly 12, while the service tool 32 is coupled with the forklift 30 in the reverse direction. In some embodiment, the coupling of the service tool 32 with the forklift 30 in the reverse direction as well as in forward direction does not require manual intervention.

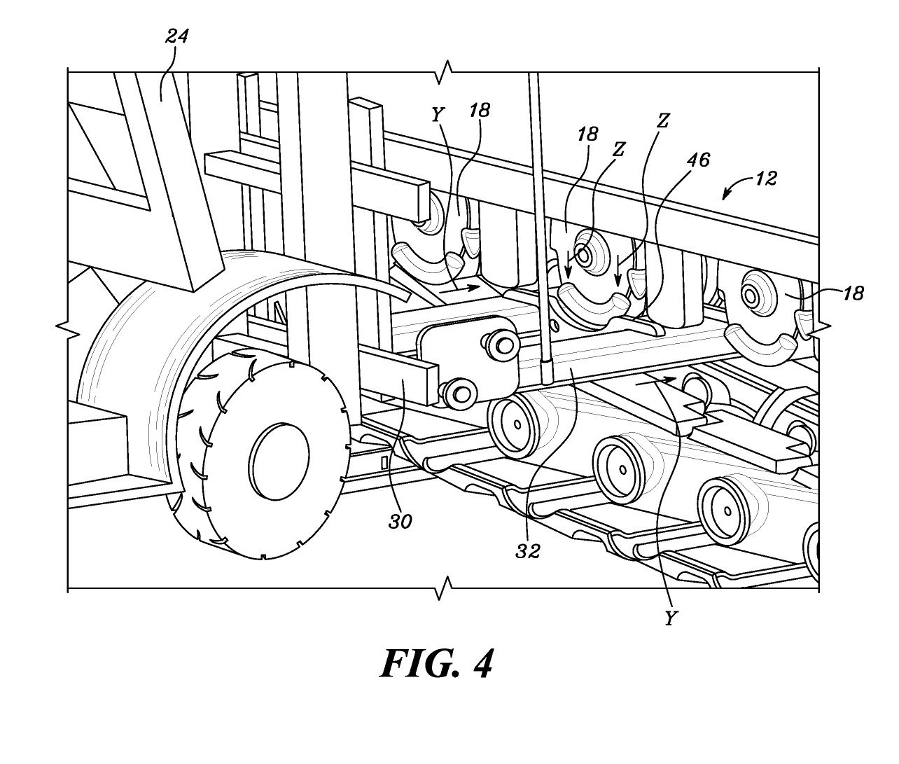

FIG. 4 is a perspective view of the service tool 32 positioned inside the undercarriage assembly 12 to replace the load roller 18, according to the concepts of the present disclosure. For carrying out procedures as shown in FIG. 4, the service tool 32 is coupled with the forklift 30 in a reverse direction. The forklift truck 24 moves the service tool 32 inside the undercarriage assembly 12 in a direction Y. For example, the forklift truck 24 carries the service tool 32 underneath the load roller 18 and halts at a position till the frames 46 of the service tool 32 are positioned under the load roller 18. In this position, the user decouples the load roller 18 from the undercarriage assembly 12, and the load roller 18 is supported onto the service tool 32 by the frames 46 as shown by a direction Z. The forklift truck 24 carrying the load roller 18 over the service tool 32 moves back to a maintenance yard for carrying out the maintenance. In the same way, the service tool 32 is used to install the load roller 18 back within the undercarriage assembly 12. The procedures described herein for installing and/or removing the load roller 18 and coupling the service tool 32 in a reverse or forward configuration with the forklift 30 require minimal or no manual intervention.

FIG. 5 is a perspective view of the load roller 18 placed on the service tool 32 coupled with the forklift 30 in the reverse direction, according to the concepts of the present disclosure. After carrying out operations as described in FIG. 4, the load roller 18 is placed over the service tool 32. The load roller 18 is secured on the service tool 32 in such a way that a bulged portion of the load roller 18 is received between the frames 46 of the service tool 32.

### INDUSTRIAL APPLICABILITY

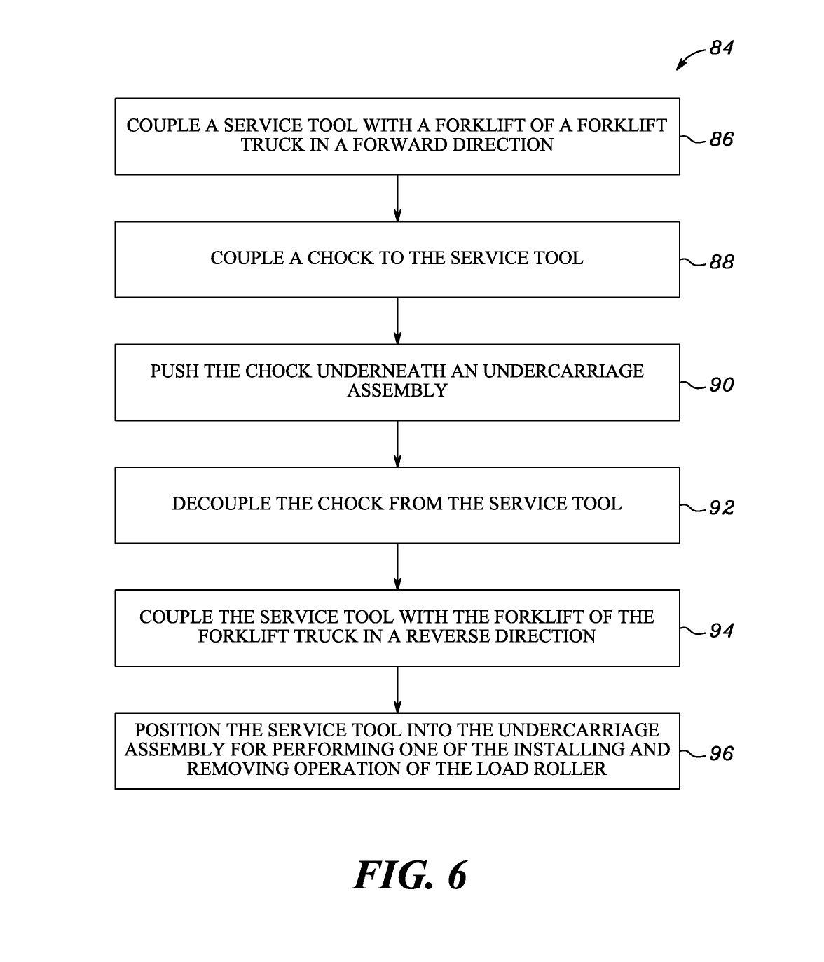

FIG. 6 is a flow diagram of a method 84 for servicing the undercarriage assembly 12, according to the concepts of the present disclosure. The method 84 is explained in conjunction with FIG. 1-5.

At step 86, the service tool 32 is coupled with the forklift 30 of the forklift truck 24 in the forward direction X.

At step 88, coupling the chock 14 with the service tool 32. As illustrated in FIG. 2, the service tool 32 is coupled with the forklift 30 of the forklift truck 24 in the forward direction X and further locks (or couples) the chock 14 with the service tool 32.

At step 90, the chock 14 is pushed underneath the undercarriage assembly 12. The chocks 14 are positioned tightly underneath the undercarriage assembly 18 in order to generate the slack 20. The slack 20 relaxes the chain 22 from the load rollers 18 that facilitates the user to carry out maintenance using the service tool 32.

At step 92, the chock 14 is decoupled from the service tool 32. After positioning the chocks 14 underneath the undercarriage assembly 12 as shown in FIG. 1, the chocks 14 are decoupled from the service tool 32 without any manual intervention.

At step 94, the service tool 32 is coupled with the forklift 30 of the forklift truck 24 in a reverse direction. For carrying out procedures as illustrated in FIG. 4, the service tool 32 is coupled with the forklift 30 in the reverse direction.

At step 96, the service tool 32 is positioned into the undercarriage assembly 12 for performing one of the installing and removing operation of the load roller 18.

The service tool 32 is designed for easy usage for operators. The service tool 32 is easily fit with the forklift 30 of the forklift truck 24 with a little or no manual intervention. The service tool 32 incorporates a flexible and robust dual-purpose design that has an ability to carry both the load rollers 18 in one application (i.e. the reverse configuration) and then be reversed to support the undercarriage assembly in another application, i.e. the forward configuration. The service tool 32 is designed in such a way that the service tool 32 is used on a wide range of hydraulic mining shovel machines.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for servicing an undercarriage assembly, the system comprising:
a service tool, wherein the service tool is capable of being coupled with a forklift of a forklift truck in one of a forward direction and a reverse direction, the service tool comprises at least one vertical pipe and optionally uses attachment modules, pins and a lock module depending on a size and weight of a load roller; and
a chock, wherein the chock is configured to be coupled with the service tool in the forward direction, the chock is pushed underneath the undercarriage assembly till the at least one vertical pipe of the service tool touches the undercarriage assembly and further the chock is decoupled from the service tool, and
wherein the service tool is further coupled with the forklift of the forklift truck in the reverse direction and the service tool is positioned into the undercarriage assembly for performing one of an installing and removing operation of the load roller from the undercarriage assembly.

2. A method for fixing a chock underneath an undercarriage assembly and further performing one of an installing and removing operation of a load roller from the undercarriage assembly, the method comprising:
coupling a service tool with a forklift of a forklift truck in a forward direction and locking the chock with the service tool, wherein the service tool includes at least one vertical pipe and the coupling of the service tool in the forward direction does not require manual intervention;
pushing the chock underneath the undercarriage assembly till the at least one vertical pipe touches the undercarriage assembly;
decoupling the chock from the service tool without any manual intervention;
coupling the service tool with the forklift of the forklift truck in a reverse direction, the service tool optionally utilizes attachment modules, pins and a lock module depending on a size and weight of the load roller, wherein the coupling of the service tool in the reverse direction does not require manual intervention; and
positioning the service tool into the undercarriage assembly for performing one of the installing and removing operation of the load roller.
